(19) United States
(12) Patent Application Publication
(10) Pub. No.: US 2017/0357104 A1
(43) Pub. Date: Dec. 14, 2017

(54) GLASSES WITH REPLACEABLE LENSES

(71) Applicant: Lin Yun CHEN, Tainan City (TW)

(72) Inventor: Lin Yun CHEN, Tainan City (TW)

(21) Appl. No.: 15/181,372

(22) Filed: Jun. 13, 2016

(51) Int. Cl. G02C 1/08; G02C 5/22; G02C 5/14; G02C 1/00

(52) U.S. Cl. CPC G02C 1/08; G02C 5/146; G02C 5/22; G02C 2200/04; G02C 2200/08; G02C 1/10

(57) ABSTRACT

A pair of glasses includes an upper spectacle frame, a lower spectacle frame, two temples, and two snap-fit components. The lower spectacle frame has two lateral ends detachably integrated with two lateral ends of the upper spectacle frame. At least one lens is installed between the upper and lower spectacle frames. Each temple is pivotally fitted to one of the lateral ends of the upper spectacle frame. Each snap-fit component includes a first end at which a snap-fit portion is designed and a second end coupled with a corresponding temple. The snap-fit portion of each snap-fit component, which is in a fixed position, is inserted into a fastening hole in the at least one lens to fix the lens. The snap-fit portion of each snap-fit component, which is in a separate position, is separated from the fastening hole for replacement of the lens.

### BACKGROUND OF THE INVENTION

### 1. Field of the Invention

The present invention relates to a pair of glasses with lenses replaceable conveniently and, more particularly, to a pair of glasses with a full-rim frame on which lenses are securely installed.

### 2. Description of the Related Art

In the era of material life promoted, people with novelty aspiration are fastidious about portable decorative objects. For example, sunglasses or leisure eyeglasses are popularized among persons who value the glasses aesthetically matching costumes. In this regard, a user who prefers versatile fancy sunglasses or leisure eyeglasses may change lenses in a pair of glasses frequently to match his/her mood or costumes but finally buy a new pair of glasses without cost effectiveness because lenses of the glasses are difficultly replaced.

In practice, a pair of conventional glasses includes a spectacle frame, two lenses, and two temples pivotally fitted at both sides of the spectacle frame. The two lenses should be held in two corresponding lens grooves opened in an inner edge of the spectacle frame. During installation of each lens, the lens should be forcibly embedded into one of the lens grooves according to elasticity of the spectacle frame in general. However, either a lens which is fragile usually or a spectacle frame could be damaged in an assembly/disassembly process.

There have been multiple conventional techniques for a pair of glasses which feature lenses replaceable conveniently and neither lenses nor a spectacle frame damaged. However, a semi-rim frame (or an upper spectacle frame) rather than a full-rim frame is available to the conventional glasses with removable lenses. Thus, the overall shape of the conventional glasses with removable lenses is limited to a semi-rim frame which has a negative effect on lenses to be installed securely.

### BRIEF SUMMARY OF THE INVENTION

Thus, an objective of the present invention is to provide a pair of glasses which is characteristic of lenses replaced by a user conveniently and available to design of a full-rim frame on which lenses are securely installed.

To achieve this and other objectives, a pair of glasses of the present invention includes an upper spectacle frame, a lower spectacle frame, two temples, and two snap-fit components. The upper spectacle frame includes two lateral ends spaced in a longitudinal direction and a mounting adapter between the two lateral ends. A slot is formed in a bottom of the mounting adapter. Each of the two lateral ends of the upper spectacle frame includes a connecting portion, and each of the connecting portions includes an internal end facing the mounting adapter and an external end spaced from the internal end in the longitudinal direction. Each of the connecting portions further includes an outside surface with a notch therein. The at least one lens includes a lower end and an upper end which is held in the upper spectacle frame. The at least one lens includes two spaced fastening hole in the upper end thereof and each adjacent to the internal end of one of the connecting portions. The lower spectacle frame includes two lateral ends spaced in the longitudinal direction and detachably integrated with the two lateral ends of the upper spectacle frame. A first joint portion upward extends from each of the lateral ends of the lower spectacle frame and is engaged in the notch in a corresponding connecting portion of the upper spectacle frame. The lower spectacle frame further includes a central portion between the two lateral ends of the lower spectacle frame, and a second joint portion upward extends from the central portion and is engaged in the slot in the mounting adapter of the upper spectacle frame. Each temple includes a front end pivotally connected to the external end of a corresponding connecting portion of the upper spectacle frame. Each snap-fit component includes spaced first and second ends, and a snap-fit portion is provided at the first end of each snap-fit component. The second end of each snap-fit component is engaged with a corresponding temple, and each snap-fit component is movable relative to the upper spectacle frame between a fixed position and a separate position. When each of the two snap-fit components is in the fixed position, the snap-fit portion of each of the two snap-fit components is engaged in one of the fastening holes of the at least one lens, and the snap-fit component covers a corresponding first joint portion of the lower spectacle frame. When each of the two snap-fit components is in the separate position, the snap-fit portion of each of the two snap-fit components is separated from one of the fastening holes of the at least one lens.

The pair of glasses of the present invention is characteristic of lenses, which are removed and replaced conveniently and fixed securely, and available to design of a full-rim frame particularly.

In a preferred form, a concave portion is formed in a top end of the notch of each connecting portion, and a first hook portion is formed at a top end of the first joint portion and engaged in the concave portion of a corresponding connecting portion. A mounting hole is provided in the mounting adapter and in communication with the slot in the mounting adapter. A second hook portion is formed at a top end of the second joint portion and engaged in the mounting hole in the mounting adapter.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is an exploded view of a pair of glasses in accordance with an embodiment of the present invention.

FIG. 2 shows another exploded view of the pair of glasses of FIG. 1.

FIG. 3 shows a perspective view of the pair of glasses of FIG. 1.

FIG. 4 is sectional view taken along line 4-4 of FIG. 3.

FIG. 5 is sectional view taken along line 5-5 of FIG. 4 and illustrates a temple and a snap-fit component in operation.

FIG. 6 is sectional view taken along line 6-6 of FIG. 3 and illustrates the snap-fit component in a fixed position.

FIG. 7 is a perspective view similar to FIG. 3 with a temple of the pair of glasses folded and illustrates the snap-fit component in a separate position.

FIG. 8 is a sectional view similar to FIG. 4 and illustrates a lower spectacle frame is separated from an upper spectacle frame.

### DETAILED DESCRIPTION OF THE INVENTION

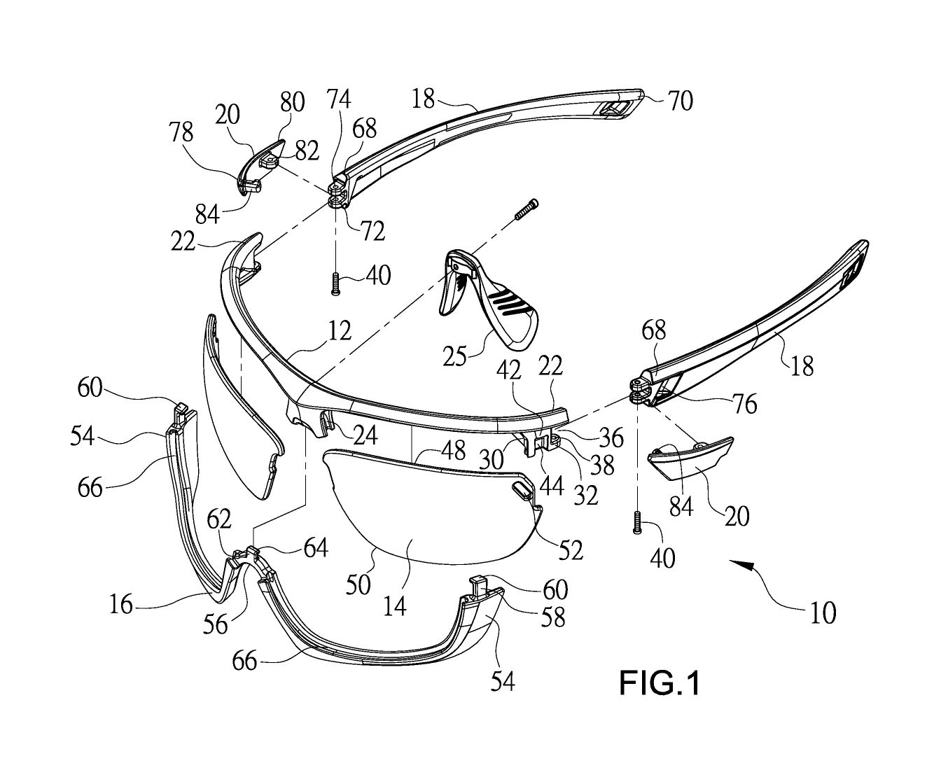

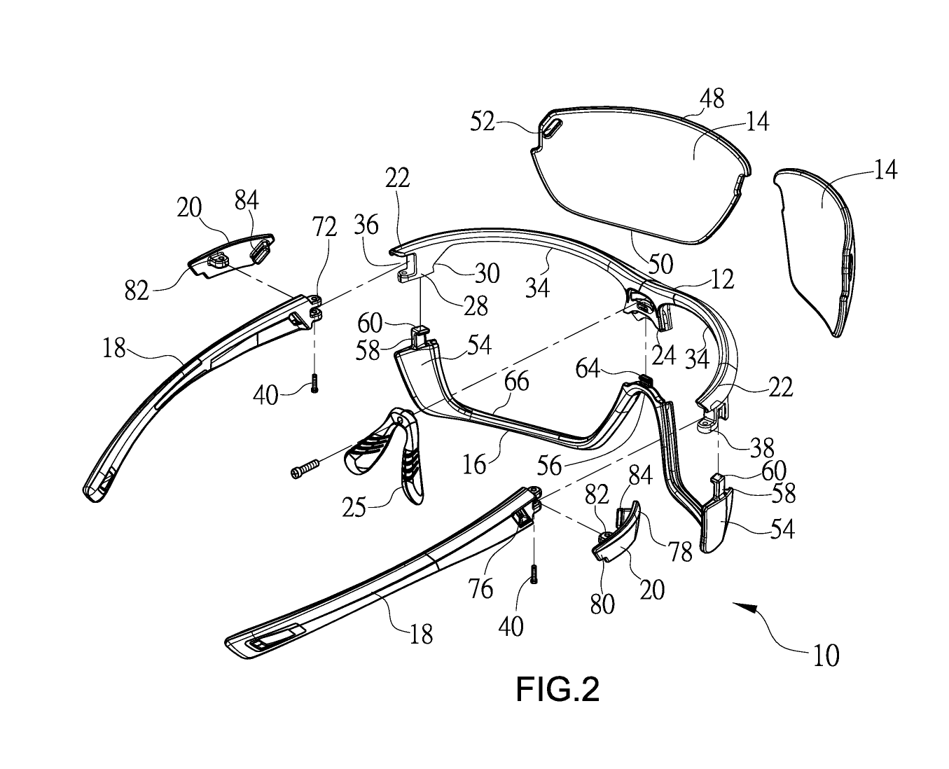

A pair of glasses 10 according to the preferred teachings of the present invention is shown in FIGS. 1 through 8 of the drawings and includes an upper spectacle frame 12, at least one lens 14, a lower spectacle frame 16, two temples 18, and two snap-fit components (first and second snap-fit components) 20. The glasses 10 may be a pair of sunglasses, leisure eyeglasses, sports eyeglasses, protective goggles, nearsighted eyeglasses, farsighted spectacles, presbyopic glasses, etc. The snap-fit components 20 which are respectively identical to each other in structure are explained according to one of the snap-fit components 20. In this embodiment, the pair of glasses 10 includes two lenses 14, but the pair of glasses 10 may include one lens 14.

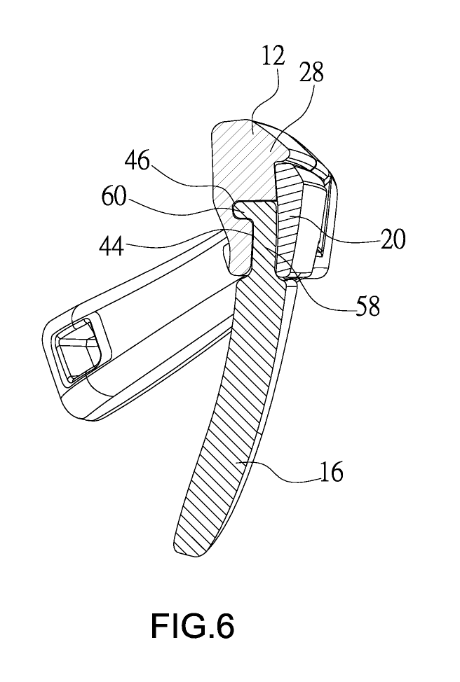

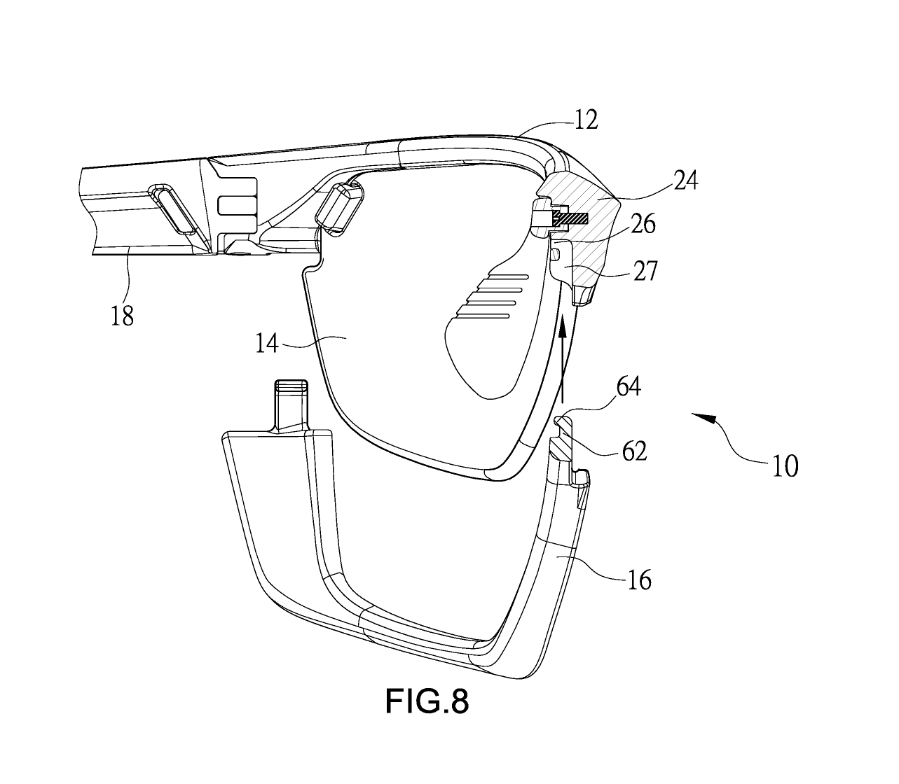

The upper spectacle frame 12 includes two lateral ends 22 spaced in a longitudinal direction. A mounting adapter 24 is formed between the lateral ends 22, and a nose pad 25 is provided at an inner side of the mounting adapter 24. A mounting hole 26 is provided in the mounting adapter 24 (see FIG. 8), and a slot 27 is formed in a bottom of the mounting adapter 24 and in communication with the mounting hole 26. Each of the lateral ends 22 of the upper spectacle frame 12 includes a connecting portion 28. In this embodiment, the connecting portions 28 are formed on bottoms of the lateral ends 22, respectively. Each of the connecting portions 28 includes an internal end 30 facing the mounting adapter 24 and an external end 32 spaced from the internal end 30 in the longitudinal direction. In this embodiment, the upper spectacle frame 12 further includes two upper lens grooves 34 in which the two lenses 14 are respectively installed. Each of the upper lens grooves 34 along an undersurface of the upper spectacle frame 12 extends to the internal end 30 of one of the connecting portions 28 from one side of the mounting adapter 24. Each temple 18 is pivotally fitted at the external end 32 of one of the connecting portions 28. In this embodiment, the external end 32 of each of the connecting portions 28 is provided with a pin-joint groove 36 and a pinhole 38 being in communication with the pin-joint groove 36 and penetrated by a pivot 40. Each of the connecting portions 28 further includes an outside surface 42 with a notch 44 therein, and a concave portion 46 is formed in a top end of the notch 44 and recessed inward (see FIG. 6).

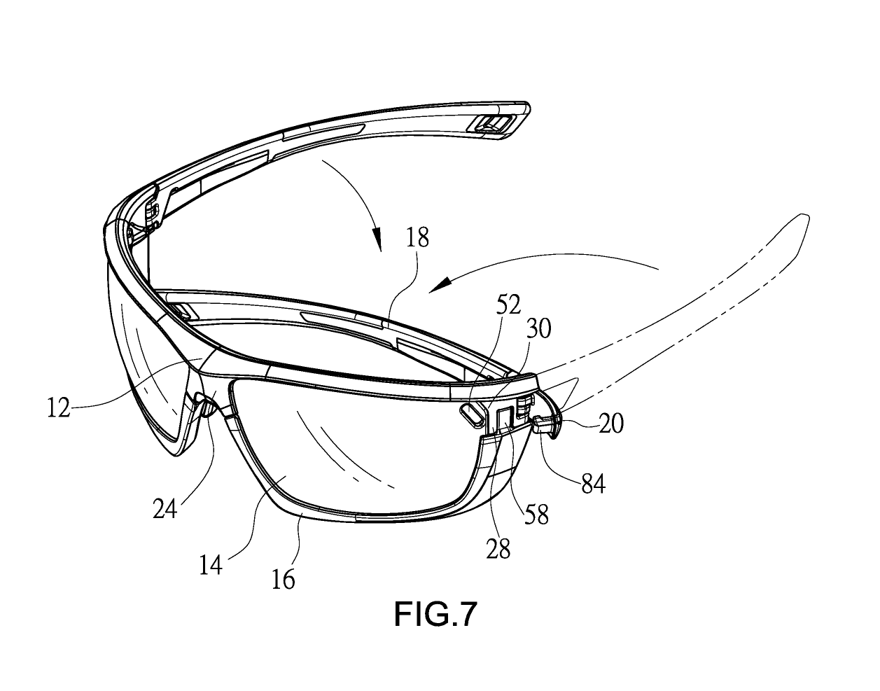

Each of the lenses 14 includes a lower end 50 and an upper end 48 which is held in one of the upper lens grooves 34 of the upper spectacle frame 12. Moreover, each of the lenses 14 includes a fastening hole 52 in an outside of the upper end 48. The fastening hole 52 in each lens 14 which has been installed on the upper spectacle frame 12 is adjacent to the internal end 30 of a corresponding connecting portion 28 (FIG. 7).

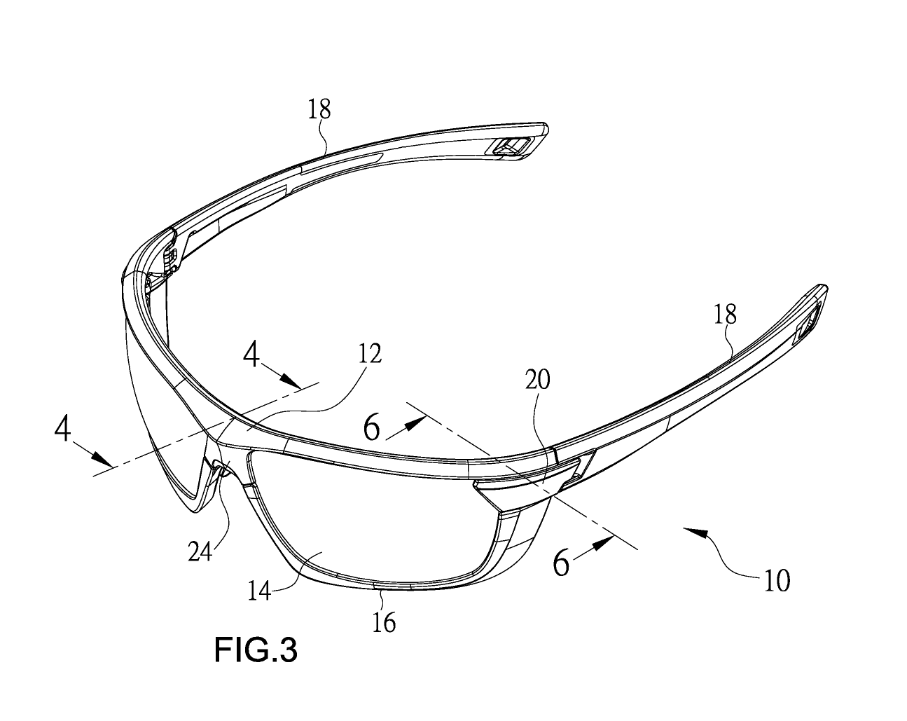

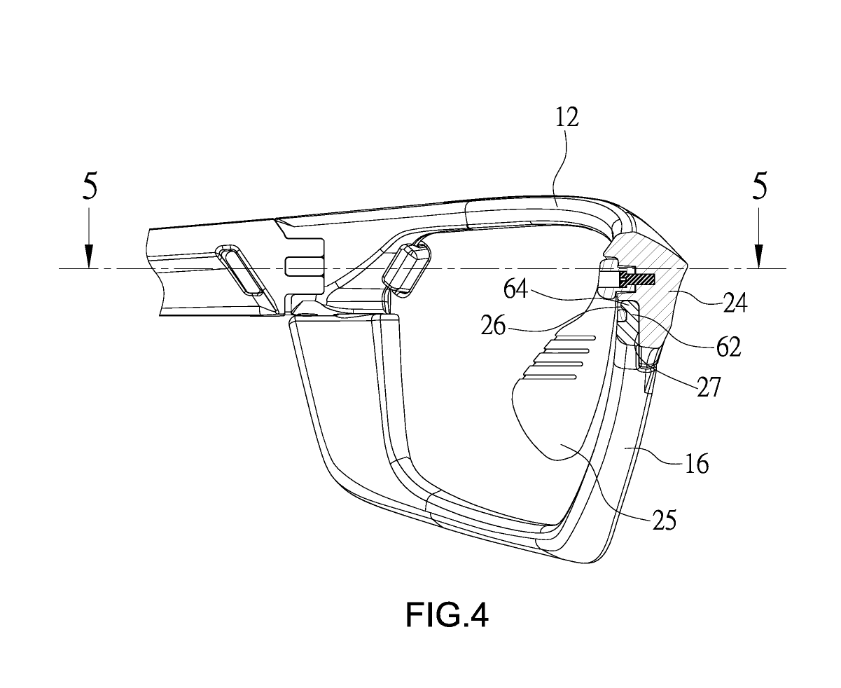

The lower spectacle frame 16 includes two lateral ends 54 spaced in the longitudinal direction and a central portion 56 between the lateral ends 54. Each of the lateral ends 54 is detachably integrated with one of the lateral ends 22 of the upper spectacle frame 12 for combination of the lower and upper spectacle frames 16 and 12 and development of a full-rim frame (FIG. 3). In this embodiment, the lower spectacle frame 16 further includes a first joint portion 58 upward extending from each of the lateral ends 54, and a first hook portion 60 is formed at a top end of the first joint portion 58. Each of the first joint portions 58 is inserted into and coupled with the notch 44 in a corresponding connecting portion 28 of the upper spectacle frame 12, and the first hook portion 60 is engaged in and fastened to the concave portion 46 of the corresponding connecting portion 28 (FIG. 6). The lower spectacle frame 16 further includes a second joint portion 62 upward extending from the central portion 56, and a second hook portion 64 is formed at a top end of the second joint portion 62 (FIG. 8). The second joint portion 62 is inserted into and integrated with the slot 27 in the mounting adapter 24 of the upper spectacle frame 12, and the second hook portion 64 is engaged in and fastened to the mounting hole 26 of the mounting adapter 24 (FIG. 4). The lower spectacle frame 16 further includes two lower lens grooves 66 in which the lower ends 50 of the two lenses 14 are respectively held. Each of the lower lens grooves 66 is extended to one of the lateral ends 54 from one side of the central portion 56 along the top of the lower spectacle frame 16.

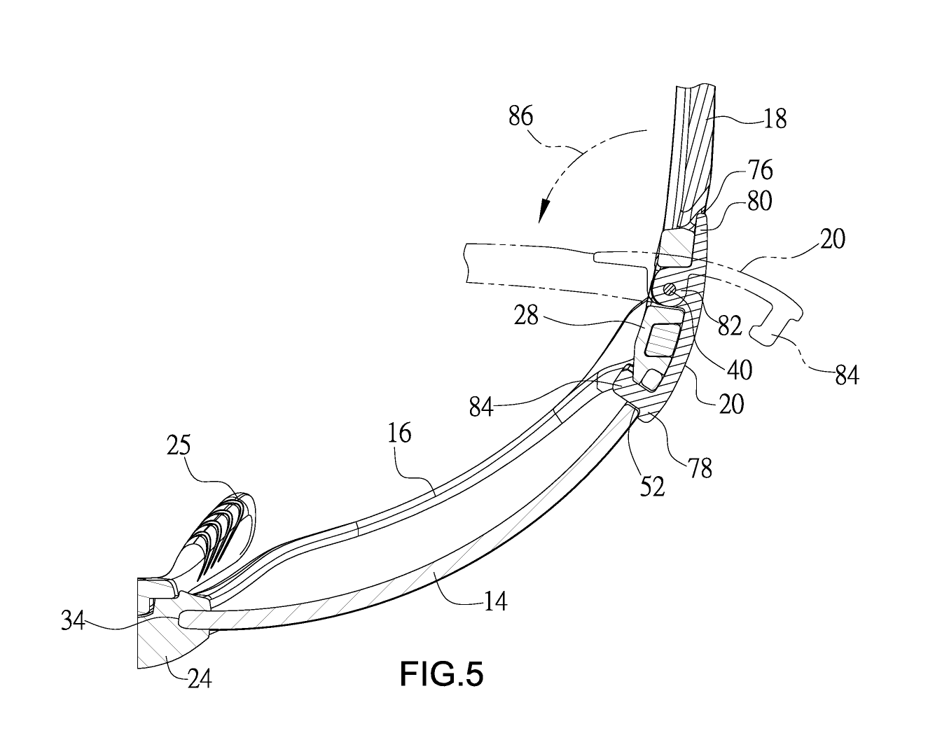

Each of the temples 18 includes front and rear ends 68 and 70 spaced in a length direction thereof The front end 68 of each temple 18 is pivotally connected to the external end 32 of a corresponding connecting portion 28 of the upper spectacle frame 12, and the rear end 70 of each temple 18 is adapted to be worn on a user's ear. In this embodiment, two spaced engaging lugs 72 are provided on the front end 68 of each of the temples 18, and each engaging lug 72 has a pinhole 74. The engaging lugs 72 of each temple 18 are held in the pin-joint groove 36 of a corresponding connecting portion 28 of the upper spectacle frame 12. When both the pinhole 38 of the corresponding connecting portion 36 and the pinholes 74 in the engaging lugs 72 are penetrated by one of the pivots 40, each of the temples 18 is integrated with the upper spectacle frame 12 and rotatable relative to the upper spectacle frame 12 between an unfolded position and a folded position about an axis defined by the pivot 40 (FIG. 5). Furthermore, each of the temples 18 has a recess 76 in the front end 68.

The snap-fit components 20 are used to fix the lenses 14. Each of the snap-fit components 20 includes spaced first and second ends 78 and 80. In this embodiment, each of the snap-fit components 20 is provided with a pin-joint lug 82, which is located at an inner side beside the second end 80, held between the engaging lugs 72 of one of the temples 18, and penetrated by the pivot 40 (FIG. 5). As such, a rotational movement based on an axis defined by the pivot 40 and relative to the upper spectacle frame 12 is completed by the snap-fit component 20 and the conjoint temple 18 between a fixed position and a separate position. Because the second end 80 of each snap-fit component 20 is held in the recess 76 of a corresponding temple 18 (FIG. 5), both the temple 18 and the snap-fit component 20 are rotated together. Each of the snap-fit components 20 includes a snap-fit portion 84 located at an inner side of the first end 78. In the case of the snap-fit component 20 stopped at the fixed position, the snap-fit portion 84 of the snap-fit component 20 is inserted into the fastening hole 52 of a corresponding lens 14 to fix the lens 14 (FIG. 5), and the snap-fit component 20 covers a corresponding first joint portion 58 of the lower spectacle frame 16 (FIG. 6). In the case of the snap-fit component 20 stopped at the separate position, the snap-fit portion 84 of the snap-fit component 20 is separated from the fastening hole 52 of the corresponding lens 14, and the first joint portion 58 of the lower spectacle frame 16 is not covered by the snap-fit component 20 (FIG. 7).

According to the glasses 10 of the present invention, the lenses 14 removed conveniently and fixed securely is available to design of a full-rim frame. Specifically, when the first end 78 of each snap-fit component 20 is lifted for disassembly of one of the lenses 14, the snap-fit component 20 at the fixed position in FIG. 5 is shifted to the separate position (both the temple 18 and the snap-fit component 20 are rotated, as shown in an arrow 86 in FIG. 5), and the snap-fit portion 84 of the snap-fit component 20 is separated from the fastening hole 52 in the lens 14. Next, the lower spectacle frame 16 is disassembled from the upper spectacle frame 12 for removal and replacement of the lenses 14 from the upper spectacle frame 12 when the first hook portions 60 of the first joint portions 58 and the second hook portion 64 of the second joint portion 62 of the lower spectacle frame 16 are separated from the concave portion 46 and the mounting hole 26 of the upper spectacle frame 12, respectively. On the other hand, the upper end 48 of each of the lenses 14 to be assembled should be first held in one of the upper lens groove 34 in the upper spectacle frame 12. Then, the lenses 14 are securely fixed between the lower spectacle frame 16 and the upper spectacle frame 12 when the lower ends 50 of the lenses 14 are embedded into the lower lens groove 66 in the lower spectacle frame 16 for combination of the lower and upper spectacle frames 16 and 12, and the snap-fit portions 84 of the snap-fit components 20 are engaged in the fastening holes 52 in the lenses 14.

The scope of the invention is to be indicated by the appended claims, rather than by the foregoing description, and all changes which come within the meaning and range of equivalency of the claims are intended to be embraced therein.

1. A pair of glasses with replaceable lenses, comprising:
an upper spectacle frame including two lateral ends spaced in a longitudinal direction and a mounting adapter between the two lateral ends, with a slot formed in a bottom of the mounting adapter, with each of the two lateral ends of the upper spectacle frame including a connecting portion, with each of the two connecting portions including an internal end facing the mounting adapter and an external end spaced from the internal end in the longitudinal direction, with each of the two connecting portions further including an outside surface with a notch therein;
two lenses including a lower end and an upper end, wherein the upper end of the two lenses is arranged in the upper lens groove of the upper spectacle frame, the upper end of the two lenses is provided with a fastening hole, and the fastening hole is adjacent to an internal end of one of the two connecting portions;
a lower spectacle frame including two lateral ends spaced in the longitudinal direction and detachably integrated with the two lateral ends of the upper spectacle frame, wherein a first joint portion extends upwards from each of the two lateral ends of the lower spectacle frame and is engaged in the notch of each of the two connecting portions of the upper spectacle frame, two sides of the lower spectacle frame are enabled to be detachably engaged with two sides of the upper spectacle frame, the lower spectacle frame further includes a central portion between the two lateral ends, and a second joint portion extends upwards from the central portion and is engaged in the slot of the mounting adapter of the upper spectacle frame;
two temples each including a front end connected to the external end of one of the two connecting portion of the upper spectacle frame; and
two snap-fit components each including spaced first and second ends, with a snap-fit portion provided at the first end of each of the snap-fit components, with the second end of each of the two snap-fit components engaged with a corresponding temple, with each of the two snap-fit components being movable relative to the upper spectacle frame between a fixed position and a separate position,
wherein when each of the two snap-fit components is in the fixed position, the snap-fit portion of each of the two snap-fit components is engaged in one of the two fastening holes of the two lenses, and the snap-fit component covers a corresponding first joint portion of the lower spectacle frame so that the pair of glasses is completely assembled, based on the combination of the upper spectacle frame, the lower spectacle frame, the two snap-fit components and the two lenses,
wherein when each of the two snap-fit components is in the separate position, the snap-fit portion of each of the two snap-fit components is separated from one of the two fastening holes of the two lenses so that the lower spectacle frame is disassembled from the upper spectacle frame, and the two lenses are completed removed from the lower spectacle frame and the upper spectacle frame, based on the separation of the upper spectacle frame, the lower spectacle frame and the two snap-fit components.

2. The glasses according to claim 1, wherein a concave portion is formed in a top end of the notch of each of the two connecting portions, with a first hook portion formed at a top end of the first joint portion and engaged in the concave portion of a corresponding connecting portion.

3. The glasses according to claim 1, wherein a mounting hole is provided in the mounting adapter and in communication with the slot in the mounting adapter, with a second hook portion formed at a top end of the second joint portion and engaged in the mounting hole in the mounting adapter.

4. The glasses according to claim 1, wherein the lower spectacle frame further includes at least one lower lens groove in which the lower end of the at least one lens is held.

5. The glasses according to claim 1, wherein the external end of each of the connecting portions is provided with a pin-joint groove and a pinhole being in communication with the pin-joint groove, with two spaced engaging lugs provided on the front end of each of the two temples and held in the pin-joint groove of a corresponding connecting portion of the upper spectacle frame, with each of the two engaging lugs having a pinhole, with both the pinhole of the corresponding connecting portion and the pinholes in the engaging lugs penetrated by a pivot, with each of the two temples being rotatable relative to the upper spectacle frame about an axis defined by the pivot.

6. The glasses according to claim 5, wherein each of the snap-fit components is provided with a pin-joint lug held between the two engaging lugs of one of the temples and penetrated by the pivot, with each of the two snap-fit components being movable between the fixed position and the separate position about the axis defined by the pivot.

7. The glasses according to claim 6, wherein each of the temples has a recess in the front end thereof, with the second end of each of the two snap-fit components held in the recess of one of the two temples.
